(19) United States
(12) Patent Application Publication
(10) Pub. No.: US 2025/0178532 A1
(43) Pub. Date: Jun. 5, 2025

(54) VEHICULAR INTERIOR REARVIEW MIRROR ASSEMBLY WITH FULL MIRROR DISPLAY

(71) Applicant: Magna Mirrors of America, Inc., Holland, MI (US)

(72) Inventor: Marshall A. Zerbe, Decatur, MI (US)

(21) Appl. No.: 18/966,218

(22) Filed: Dec. 3, 2024

Related U.S. Application Data
(60) Provisional application No. 63/606,129, filed on Dec. 5, 2023.

(51) Int. Cl. B60R 1/12; B60R 1/04; B60R 1/08; B60R 1/26

(52) U.S. Cl. CPC B60R 1/12; B60R 1/04; B60R 1/088; B60R 1/26; B60R 2001/1253; B60R 2300/8066

(57) ABSTRACT

A vehicular interior rearview mirror assembly includes a mirror head accommodating a mirror reflective element. The mirror head is adjustable by a driver of a vehicle to set a rearward view for the driver. The mirror reflective element has a single glass substrate, with a second planar surface opposite and parallel to a first planar surface and separated by a thickness of the single glass substrate. The mirror head accommodates a video display screen that is electrically operable to display video images for viewing by the driver through a mirror reflector disposed at the single glass substrate. An adjustment mechanism that is operable to adjust the mirror head between a mirror mode orientation and a display mode orientation. Responsive to the mirror head being adjusted to the display mode orientation, the video display screen is automatically electrically operated to display video images representative of the rearward view.

### CROSS REFERENCE TO RELATED APPLICATION

The present application claims the filing benefits of U.S. provisional application Ser. No. 63/606,129, filed Dec. 5, 2023, which is hereby incorporated herein by reference in its entirety.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a double ball pivot or joint mounting configuration where the mirror casing and reflective element are adjusted relative to the interior portion of a vehicle by pivotal movement about the double ball pivot configuration. The mirror casing and reflective element are pivotable about either or both of the ball pivot joints by a user that is adjusting a rearward field of view of the reflective element. It is also generally known to provide an interior mirror assembly with a prismatic reflective element that may be manually toggled between daytime and nighttime reflectivity positions, such as described in U.S. Pat. No. 6,318,870, which is hereby incorporated herein by reference in its entirety.

### SUMMARY OF THE INVENTION

A vehicular interior rearview mirror assembly includes a mounting structure configured to attach to an interior portion of a cabin of a vehicle equipped with the vehicular interior rearview mirror assembly. A mirror head accommodates a mirror reflective element that includes a single glass substrate having a first surface and a second surface. The second surface is opposite the first surface and separated by a thickness of the glass substrate, and a mirror reflector is disposed at the second surface of the glass substrate. With the mounting structure attached at the interior portion of the cabin of the vehicle, the mirror head is adjustable by a driver of the vehicle to set a rearward view for the driver. The mirror head accommodates a video display screen that is electrically operable to display video images for viewing by the driver. The mirror assembly includes a toggle mechanism that, with the mounting structure attached at the interior portion of the cabin of the vehicle, is operable to adjust the mirror head between a mirror mode orientation and a display mode orientation. In the mirror mode orientation, the mirror head is positioned relative to the mounting structure so that reflections at the mirror reflective element provide the rearward view for the driver. In the display mode orientation, the mirror head is tilted from the mirror mode orientation so that reflections at the mirror reflective element are directed away from the driver and the video display screen is electrically operated to display video images representative of the rearward view for viewing by the driver. The mirror reflective element may comprise a planar single glass substrate and is adjustable between the mirror mode orientation and the display mode orientation to direct reflections away from the driver such that electronic dimming circuitry is not needed.

These and other objects, advantages, purposes and features of the present invention will become apparent upon review of the following specification in conjunction with the drawings.

### BRIEF DESCRIPTION OF THE DRAWINGS

FIGS. 1 and 2 are perspective views of an interior rearview mirror assembly; and

FIG. 3 is a sectional view of the interior rearview mirror assembly.

### DESCRIPTION OF THE PREFERRED EMBODIMENTS

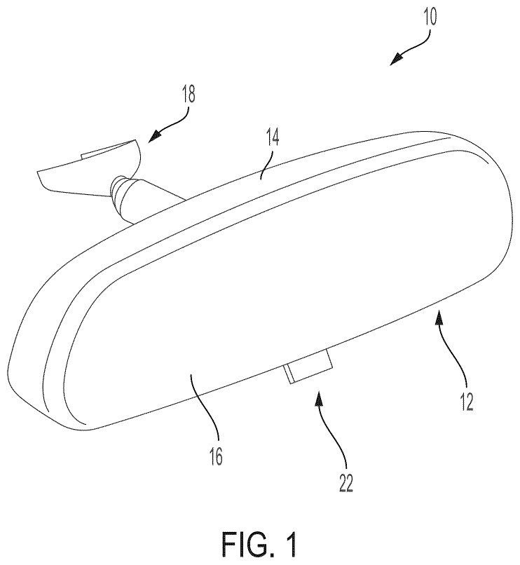

Referring now to the drawings and the illustrative embodiments depicted therein, an interior rearview mirror assembly 10 for a vehicle includes a mirror head 12 that includes a casing 14 and a reflective element 16 positioned at a front portion of the casing 14 (FIG. 1). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 18. The mirror head 12 accommodates a video display screen 20 that is operable to display video images that are viewable by the driver of the vehicle through the mirror reflective element 16.

The mirror head 12 is tiltable or pivotable between a mirror mode orientation, where the reflective element 16 is positioned to provide reflections for the desired driver's rearward field of view, and a display mode orientation, where the mirror head is tilted upward (or downward) from the mirror mode orientation, such that video images displayed at the display screen 20 are viewable by the driver while the reflective element 16 reflects light from rearward of the vehicle and incident thereon upward or downward away from the driver's eyes. The mirror head 12 may be tiltable or pivotable between the mirror mode orientation and the display mode orientation via a toggle element or mechanism or adjustment mechanism 22. That is, the toggle element 22 may include a switch or lever that is graspable by a user and pivotable relative to the mirror head 12 to cause movement of the mirror head 12 and/or mirror reflective element 16 relative to the mounting structure 18 between discrete pivot positions. For example, the mirror head 12 may be manually pivotable between the mirror mode orientation and the display mode orientation by a user grasping the toggle element 22 to pivot the mirror head 12.

The interior rearview mirror assembly thus can be used as a reflecting mirror assembly, but can also be changed to a video monitor, such as through use of a transflective surface and a high intensity display transposed behind the transflective surface. In other words, the mirror is provided with a video display screen that is disposed behind and is viewable through the mirror reflective element. Such video mirrors include a backlit LCD display screen, and a particular form of video mirror is a full display mirror (such as a ClearView™ Interior Rearview Mirror Assembly available from Magna Mirrors of America, Inc. of Holland, MI USA, or an FDM™ Interior Rearview Mirror Assembly available from Gentex Corporation of Zeeland, MI USA), where the video display screen fills or substantially fills the reflective region (e.g., fills or encompasses at least about 75 percent of the reflective region, or at least about 85 percent of the reflective region, or at least about 95 percent of the reflective region), such as by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2024-0383405; US-2024-0064274; US-2021-0162926; US-2021-0155167; US-2020-0377022; US-2019-0258131; US-2019-0146297; US-2019-0118717 and/or US-2017-0355312, which are all hereby incorporated herein by reference in their entireties.

The video display screen 20 of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. The operating mode of the mirror and video display screen may be selected by flipping the mirror head upward or downward (e.g., via the toggle 22 located at the mirror head) or responsive to another user input. When the mirror is operating in the mirror mode, the video display screen 20 is deactivated and rendered covert by the mirror reflective element 16, and the driver views rearward via reflection of light incident at the mirror reflective element 16. When the mirror is operating in the display mode, the video display screen 20 is operated to display video images that are viewable through the mirror reflective element 16 by the driver of the vehicle.

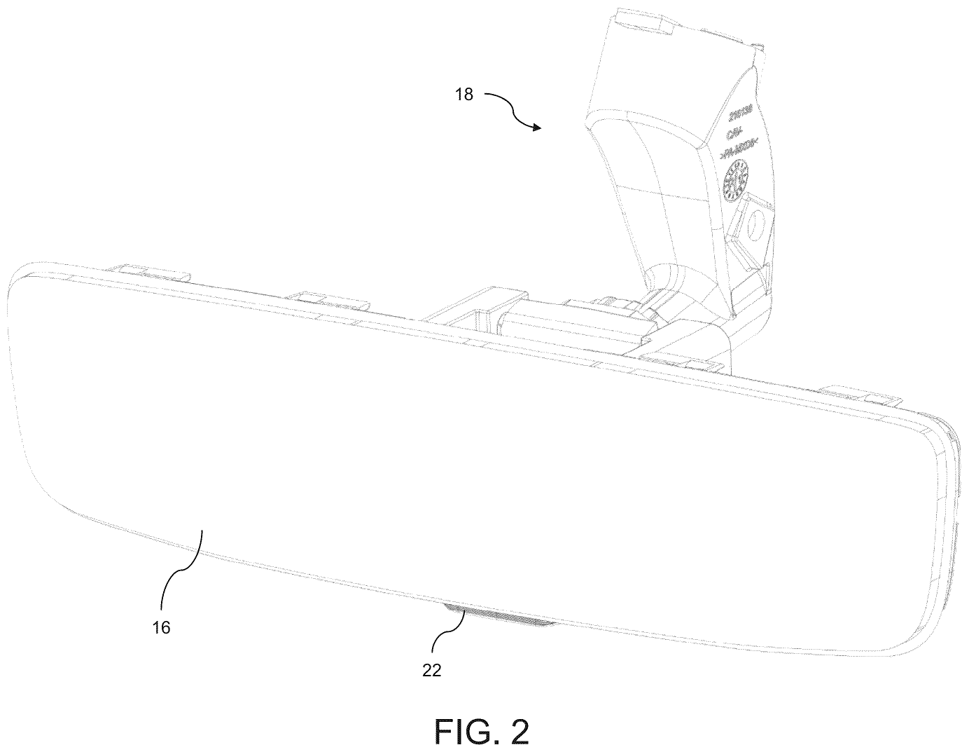

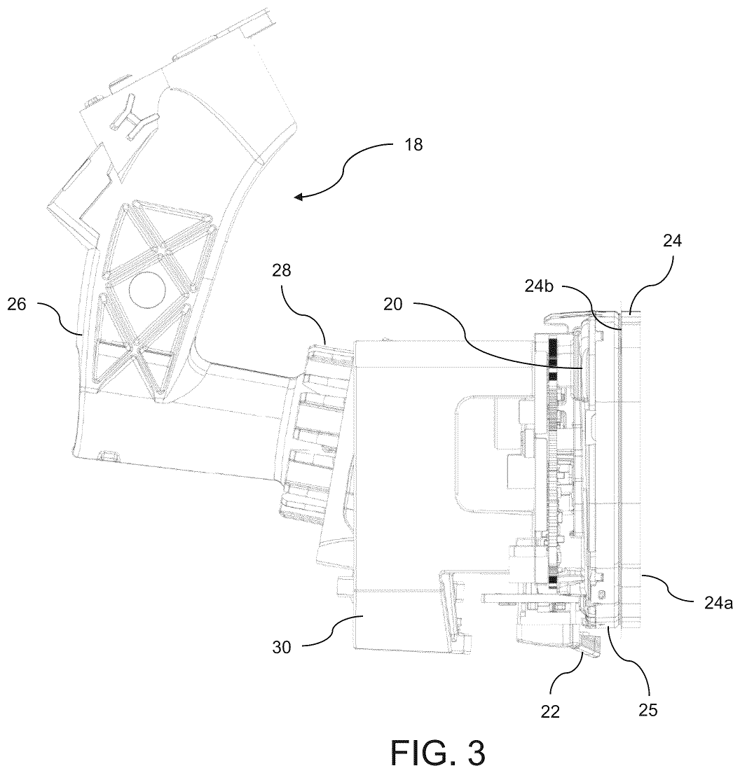

Referring to FIGS. 2 and 3, the mirror reflective element 16 comprises a flat or planar glass substrate 24 having a front or first surface 24a (the surface that generally faces the driver of the vehicle when the mirror assembly is normally mounted at the vehicle) and a rear or second surface 24b opposite the first surface 24a, where the first surface 24a and the second surface 24b may be parallel to one another. The second surface 24b has a reflective coating, such as a metallic reflector coating (or multiple layers or coatings), established thereat for reflecting at least a portion of light incident at the glass substrate 24 to provide the reflections for viewing by the driver of the vehicle. The mirror reflective element and mirror reflector may utilize aspects of the mirror reflective elements and mirror reflectors described in U.S. Pat. No. 11,639,134, and/or U.S. provisional application 63/651,537, filed May 24, 2024, and/or U.S. provisional application Ser. No. 63/641,574, filed May 2, 2024, which are hereby incorporated herein by reference in their entireties.

The video display screen 20 is accommodated within the mirror head and behind the glass substrate 24 and the reflective coating at the second surface 24b allows at least a portion of light incident thereat to pass through the glass substrate 24 so that, when the video display screen 20 is operated to display video images, the video images are viewable through the mirror reflective element 16. When the video display screen 20 is not being operated, the reflective coating at the second surface 24b of the glass substrate 24 reflects and/or attenuates at least a portion of light incident thereat to at least partially hide or render covert the video display screen 20 so that the driver may not be able to view the video display screen 20 and instead views reflections at the mirror reflective element 16.

Optionally, the glass substrate 24 includes the reflector coating and one or more additional films or coatings disposed thereat and configured to transmit at least a portion of light incident thereat and to reflect and/or attenuate at least a portion of light incident thereat. The reflector coating (and optionally the one or more additional coatings or films) may transmit a relatively low portion of light incident thereat to render the video display screen 20 hidden or covert when not operated to emit light, and the video display screen 20 may be operable to emit light at an intensity that is high enough so that light emitted by the video display screen passes through the reflector coating and/or additional coatings or films so that the displayed images are easily viewable at the mirror reflective element 16.

When the mirror head 12 is in the mirror mode orientation, the mirror head 12 is positioned so that the mirror reflective element 16 provides a desired field of view rearward of the vehicle to the driver and the video display screen 20 is not operated. When the mirror head 12 is toggled to the display mode orientation, the mirror head 12 is pivoted upward or downward relative to the mirror mode orientation so that the reflections from the mirror reflective element 16 are directed upward or downward away from view of the driver and the video display screen 20 is operated so that video images at the video display screen 20 are viewable by the driver. The video display screen 20 may be automatically operated upon movement of the mirror head 12 to the display mode orientation.

The mounting structure 18 of the mirror assembly 10 allows for the mirror head 12 to pivot upward and/or downward between the mirror mode orientation and the display mode orientation. For example, the mounting structure 18 includes a mounting arm or stay 26 configured to mount at the interior portion of the vehicle (e.g., at an in-cabin surface of the windshield of the vehicle, at a headliner of the vehicle, and the like) and having a ball member at an end of the mounting arm 26. The ball member of the mounting arm 26 is pivotally received in a socket element 28 that is attached at or integrally formed with the mirror head 12. For example, the socket element 28 may be attached at or integrally formed with the mirror casing 14 or a mirror back plate attached to the mirror reflective element 16 or other suitable structure 30 of the mirror head 12.

When the mirror head 12 is adjusted relative to the mounting structure 18 to adjust the rearward field of view provided by the mirror reflective element 16, the socket element 28 allows for pivoting of the mirror head 12 about the ball member. When the mirror head 12 is adjusted between the mirror mode orientation and the video mode orientation, the mirror head 12 tilts or pivots upward and/or downward relative to the socket element 28 and the mirror head 12 may pivot about a pivot axis that is parallel to a longitudinal axis of the mirror head 12. For example, the socket element 28 may be pivotally attached to the mirror back plate or other structure 30 of the mirror head 12 and, when the mirror head 12 is toggled between the mirror mode orientation and the display mode orientation, the structure 30 pivots relative to the socket element 28 to move the mirror head 12.

The mounting structure 18 of the mirror assembly 10 comprises a two-position toggle mechanism, such that the mirror head 12 may be adjustable between the mirror mode orientation and the display mode orientation and the mirror head 12 may not be pivoted to and retained at a position between the mirror mode orientation and the display mode orientation. For example, a detent interface may be disposed between the socket element 28 and the structure 30 of the mirror head 12 with detent positions corresponding to the mirror mode orientation and the display mode orientation for positioning the mirror head 12 and retaining the mirror head 12 in the desired position. Optionally, the mirror head 12 may be biased toward the mirror mode orientation and/or the display mode orientation to urge the mirror head 12 toward one of the positions in the event of partial or incomplete movement between the positions.

Thus, the mirror head 12 is manually pivotable between the mirror mode orientation and the display mode orientation by grasping the toggle element 22 and pivoting the mirror head 12 about the socket element 28. Responsive to the mirror head 12 being moved to the display mode orientation, the display screen 20 may be automatically operated to display video images and, responsive to the mirror head 12 being moved away from the display orientation, the display screen 20 may cease operation. For example, responsive to the detent interface between the socket element 28 and the structure 30 of the mirror head 12 being engaged at the display mode orientation, operation of the video display screen may be triggered, such as upon electrical connection between electrical contacts at the respective detent interfaces, compression of a button as the mirror head 12 moves to the display mode orientation, and the like. In some examples, the mirror head 12 may be moved between the mirror mode orientation and the display mode orientation via operation of an actuator, such as by utilizing characteristics of U.S. Pat. No. 10,442,360, which is incorporated herein by reference in its entirety.

The mirror reflective element 16 comprises a single glass substrate 24 with a single surface mirror reflector and does not include an electrically operable dimming mechanism (such as a dimmable electrochromic medium) such that the reflections from the reflector coating at the second surface 24b of the mirror reflective element are not electronically dimmable. The video images displayed at the mirror assembly 10 may be representative of the rearward field of view provided by the mirror assembly and the video images may be digitally adjusted to dim the images, such as to account for glare from headlights of other vehicles following the equipped vehicle. Accordingly, the driver may choose to position the mirror head 12 in the mirror mode orientation during daytime driving and choose to position the mirror head 12 in the display mode orientation during nighttime driving, or the driver may choose to position the mirror head 12 in the display mode orientation during daytime and nighttime driving and the video images may be adjusted based on glare light and/or ambient light detected at the mirror assembly 10. In other words, during nighttime driving, the driver may adjust the mirror head 12 from the mirror mode orientation to the display mode orientation so that reflections from the mirror reflective element 16 may be directed generally upward toward the headliner of the vehicle and the display screen 20 may be operated to display video images representative of the view rearward of the vehicle. Optionally, the mirror assembly 10 may automatically adjust or toggle to the display mode orientation (and the display screen may be activated) responsive to detecting glare light incident at the mirror reflective element. Further, the mirror assembly 10 may adjust or toggle to the display mode orientation (and the display screen may be activated) responsive to determining that a level of ambient light at the interior cabin of the vehicle is greater than a threshold level of ambient light (e.g., when the video display screen is operated for daytime driving) and/or responsive to determining that the level of ambient light at the interior cabin of the vehicle is less than a threshold level of ambient light (e.g., when the video display screen is operated for nighttime driving).

In some examples, with the mirror head 12 in the mirror mode orientation and with the display screen 20 not displaying video images representative of the rearward view provided by the mirror assembly 10, the display screen 20 may be operated to adjust the color of the display screen 20 and thus to adjust a background color of the mirror reflective element 16, such as to reduce reflections of glare light incident at the mirror reflective element 16. That is, based on determination or detection of glare light incident at the mirror reflective element 16, the display screen 20 may be operated to display a color that better absorbs light incident at the mirror reflective element 16 and thus reduces reflections of glare light incident thereat. For example, the backlight of the LCD display screen may be adjusted or operated to emit light at a color that absorbs or attenuates at least a portion of light incident at the mirror reflective element 16.

Because the mirror assembly 10 does not include an electrically operable dimming mechanism, the mirror assembly may not include circuitry, components or software associated with electronic dimming. This allows for cost and size reduction of the mirror assembly. In other words, the mirror assembly comprises a single surface reflector full video mirror vehicular interior rearview mirror assembly. Cost reduction is accomplished by providing a flat glass reflector and removing the electrochromic (EC) cell. By doing this, it allows for removal of the EC electrification circuitry, components, and software. To control glare, the mirror assembly has dual position toggle functionality. In the standard position, when the toggle has not been actuated, the mirror assembly may act as a single surface reflector interior mirror. When the toggle is actuated, the mirror is tilted upward (or optionally downward), which shifts the reflections from the interior rearview mirror assembly toward the vehicle's headliner (or toward the floor of the vehicle). The actuation also powers on the video functionality, which provides to the driver a view from the vehicle's cameras, which may be located throughout the exterior of the vehicle (such as a rearward viewing camera).

In some examples, the mirror reflective element may comprise a prismatic glass substrate having a front or first surface (the surface that generally faces the driver of the vehicle when the mirror assembly is normally mounted at the vehicle) and a rear or second surface opposite the first surface, where the first surface and the second surface are at an oblique angle relative to one another. The reflective coating may be disposed at the second surface. In these examples, the mirror head may be adjustable between a daytime mirror mode orientation, where the mirror head is configured to provide a brighter reflection for viewing by the driver (e.g., the reflection is from the second surface), a nighttime mirror mode orientation, where the mirror head is tilted upward from the daytime mirror mode orientation (e.g., five degrees) to provide a dimmer reflection for viewing by the driver (e.g., the reflection is from the first surface), and a display mode orientation, where the mirror head is tilted upward from the nighttime mirror mode orientation (e.g., an additional five degrees for total movement of ten degrees from the daytime orientation) and the display screen is operated to display video images for viewing by the driver.

When the mirror reflective element comprises a prismatic glass substrate, the mounting structure may comprise a three-position toggle mechanism, such that the mirror head may be adjustable between the daytime mirror mode orientation, the nighttime mirror mode orientation, and the display mode orientation and the mirror head may not be pivoted to positions between the respective orientations, such as by utilizing aspects of the mirror assemblies described in U.S. Publication No. US-2024-0383405, which is hereby incorporated herein by reference in its entirety. Respective detent positions of the detent interface between the socket element and the structure of the mirror head may correspond to the different orientations. Thus, the toggle element 22 may be grasped to move the mirror head between each of the positions. The display screen may be automatically operated to display video images responsive to the mirror head being adjusted to the display mode orientation, and the display screen may not operate to display video images in the daytime and the nighttime mirror mode orientations. For example, when the mirror head is moved to the display mode orientation, electrical contacts at the detent interface (i.e., between the socket element and the structure of the mirror head) may trigger operation of the video display screen.

Thus, the mirror assembly may include a single glass substrate having a mirror reflector coating for providing reflections for viewing by the driver of the vehicle. A display screen is disposed behind the mirror reflective element for displaying video images representative of the rearward view that are viewable by the driver through the mirror reflective element. Because the mirror reflective element may include a single glass substrate without electrically operable dimming components, the mirror head is pivotable relative to the mounting structure upward or downward to direct reflections upward or downward and away from view of the driver when the display screen is operated to display video images.

The back plate 25 may comprise any suitable construction. Optionally, for example, a common or universal backplate, whereby the appropriate or selected socket element or pivot element (such as a socket element or such as a ball element or the like) is attached to the backplate to provide the desired pivot joint for the particular mirror head in which the backplate is incorporated. Optionally, when molding the backplate, a different insert may be provided to integrally mold a portion of or all of a ball member or the like (such as a portion of a base of a ball member, whereby the ball member may comprise a metallic ball member that is insert molded at the base and at the rear of the backplate during the injection molding process that forms the backplate, such as by utilizing aspects of the mirror assemblies described in U.S. Pat. Nos. 7,855,755; 7,249,860 and 6,329,925 and/or U.S. Pat. Pub. No. US-2006-0061008, which are hereby incorporated herein by reference in their entireties).

The reflective element and mirror casing are adjustable relative to a base portion or mounting assembly to adjust the driver's rearward field of view when the mirror assembly is normally mounted at or in the vehicle. The mounting assembly may comprise a single-ball or single-pivot mounting assembly, whereby the reflective element and casing are adjustable relative to the vehicle windshield (or other interior portion of the vehicle) about a single pivot joint, or the mounting assembly may comprise other types of mounting configurations, such as a double-ball or double-pivot mounting configuration or the like. The socket or pivot element is configured to receive a ball member of the base portion, such as for a single pivot or single ball mounting structure or a double pivot or double ball mounting structure or the like (such as a pivot mounting assembly of the types described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860 and/or 6,483,438, which are hereby incorporated herein by reference in their entireties).

The mounting base includes an attaching portion that is configured to be attached to an interior surface of a vehicle windshield (such as to a mounting button or attachment element adhered to the interior surface of the vehicle windshield or such as to a headliner or overhead console of the vehicle). The mounting base may comprise a metallic ball portion or may comprise a molded (such as injection molded) polymeric mounting base or may be otherwise formed, depending on the particular application of the mirror assembly.

The mirror assembly may comprise a prismatic reflective element. The prismatic mirror assembly may be mounted or attached at an interior portion of a vehicle (such as at an interior surface of a vehicle windshield) via the mounting means described above, and the reflective element may be toggled or flipped or adjusted between its daytime reflectivity position and its nighttime reflectivity position via any suitable toggle means, such as by utilizing aspects of the mirror assemblies described in U.S. Pat. Nos. 6,318,870 and/or 7,249,860, and/or U.S. Publication No. US-2010-0085653, which are hereby incorporated herein by reference in their entireties. Optionally, for example, the interior rearview mirror assembly may utilize aspects of a prismatic mirror assembly, such as the types described in U.S. Pat. Nos. 7,289,037; 7,249,860; 6,318,870; 6,598,980; 5,327,288; 4,948,242; 4,826,289; 4,436,371 and/or 4,435,042, and/or U.S. Publication No. US-2024-0075878 and/or U.S. patent application Ser. No. 18/817,442, filed Aug. 28, 2024 (Attorney Docket DON01 P5192), which are hereby incorporated herein by reference in their entireties. Optionally, the prismatic reflective element may comprise a conventional prismatic reflective element or prism or may comprise a prismatic reflective element of the types described in U.S. Pat. Nos. 7,420,756; 7,289,037; 7,274,501; 7,249,860; 7,338,177 and/or 7,255,451, which are all hereby incorporated herein by reference in their entireties.

Optionally, image data captured by a rearward-viewing camera (e.g., a rear backup camera or other rearward-viewing camera disposed at a rear portion of the vehicle, or a driver or occupant or cabin monitoring camera that views rearward within the cabin of the vehicle and rearward of the vehicle via a rear window of the vehicle) may be image processed to determine ambient light (and/or glare light) present at the vehicle. Thus, for example, during nighttime driving, image processing of captured image data can be used to appropriately control the intensity of backlighting of the video display screen to be appropriate for nighttime driving. Also, for example, during high ambient driving, the backlighting is increased so the displayed images are not washed out. The intelligent/automatic mirror dimming functions and/or video display screen dimming functions may utilize aspects of the systems described in U.S. Pat. Nos. 11,780,372; 11,242,008; 10,967,796 and/or 10,948,798, and/or U.S. Publication No. US-2024-0064274, which are all hereby incorporated herein by reference in their entireties.

Optionally, the mirror assembly may include one or more other displays, such as the types disclosed in U.S. Pat. Nos. 5,530,240 and/or 6,329,925, which are hereby incorporated herein by reference in their entireties, and/or display-on-demand transflective type displays, and/or video displays or display screens, such as the types disclosed in U.S. Pat. Nos. 11,766,968; 8,890,955; 7,855,755; 7,338,177; 7,274,501; 7,255,451; 7,195,381; 7,184,190; 7,046,448; 5,668,663; 5,724,187; 5,530,240; 6,329,925; 6,690,268; 7,734,392; 7,370,983; 6,902,284; 6,428,172; 6,420,975; 5,416,313; 5,285,060; 5,193,029 and/or 4,793,690, and/or in U.S. Pat. Pub. Nos. US-2006-0050018; US-2009-0015736; US-2009-0015736; and/or US-2010-0097469, which are all hereby incorporated herein by reference in their entireties.

The video display screen may be controlled or operable in response to an input or signal, such as a signal received from one or more cameras or image sensors of the vehicle, such as a video camera or sensor, such as a CMOS imaging array sensor, a CCD sensor or the like, and image processors or image processing techniques, such as utilizing aspects of the cameras and image processors described U.S. Pat. Nos. 5,550,677; 5,670,935; 5,760,962; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606 and/or 7,720,580, and/or U.S. Pat. Pub. Nos. US-2006-0171704; US-2009-0244361 and/or US-2010-0214791, and/or International Publication Nos. WO 2009/046268 and/or WO 2009/036176, which are all hereby incorporated herein by reference in their entireties, or from one or more imaging systems of the vehicle, such as a reverse or backup aid system, such as a rearwardly directed vehicle vision system utilizing principles disclosed in U.S. Pat. Nos. 5,550,677; 5,760,962; 5,670,935; 6,201,642; 6,396,397; 6,498,620; 6,717,610 and/or 6,757,109, which are hereby incorporated herein by reference in their entireties, a trailer hitching aid or tow check system, such as the type disclosed in U.S. Pat. No. 7,005,974, which is hereby incorporated herein by reference in its entirety, a cabin viewing or monitoring device or system, such as a baby viewing or rear seat viewing camera or device or system or the like, such as disclosed in U.S. Pat. Nos. 5,877,897 and/or 6,690,268, which are hereby incorporated herein by reference in their entireties, a video communication device or system, such as disclosed in U.S. Pat. No. 6,690,268, which is hereby incorporated herein by reference in its entirety, and/or the like. The imaging sensor or camera may be activated and the display screen may be activated in response to the vehicle shifting into reverse, such that the display screen is viewable by the driver and is displaying an image of the rearward scene while the driver is reversing the vehicle. It is envisioned that an image processor or controller (such as an EYEQ™ image processing chip available from Mobileye Vision Technologies Ltd. of Jerusalem, Israel, and such as an image processor of the types described in U.S. Pat. No. 9,126,525, which is hereby incorporated herein by reference in its entirety) may process image data captured by the rearward facing camera to assess glare lighting conditions (such as to detect headlights of following vehicles that may cause glare at the interior and/or exterior rearview mirror assemblies of the equipped vehicle), and the controller may adjust or control the dimming of the electro-optic mirror assembly or assemblies of the equipped vehicle responsive to such image processing.

Changes and modifications in the specifically described embodiments may be carried out without departing from the principles of the present invention, which is intended to be limited only by the scope of the appended claims as interpreted according to the principles of patent law.

1. A vehicular interior rearview mirror assembly, the vehicular interior rearview mirror assembly comprising:
a mirror head adjustable relative to a mounting structure, wherein the mounting structure is configured to mount the vehicular interior rearview mirror assembly at an interior portion of an interior cabin of a vehicle;
wherein the mirror head accommodates a mirror reflective element;
wherein the mirror reflective element consists of a single glass substrate having a first planar surface and a second planar surface opposite the first planar surface and separated from the first planar surface by a thickness of the single glass substrate, and wherein the second planar surface is parallel to the first planar surface, and wherein the single glass substrate has a mirror reflector;
wherein, with the vehicular interior rearview mirror assembly mounted at the interior portion of the interior cabin of the vehicle, the mirror head is adjustable by a driver of the vehicle to set a rearward view for the driver of the vehicle;
wherein the mirror head accommodates a video display screen;
wherein, with the vehicular interior rearview mirror assembly mounted at the interior portion of the interior cabin of the vehicle, the video display screen is electrically operable to display video images for viewing by the driver of the vehicle through the mirror reflector of the mirror reflective element;
an adjustment mechanism that, with the vehicular interior rearview mirror assembly mounted at the interior portion of the interior cabin of the vehicle, is operable to adjust the mirror head between (i) a mirror mode orientation where the mirror head is positioned relative to the mounting structure so that reflections at the mirror reflective element provide the rearward view for the driver of the vehicle and (ii) a display mode orientation where the mirror head is tilted from the mirror mode orientation so that reflections at the mirror reflective element are directed away from the driver of the vehicle; and
wherein, with the vehicular interior rearview mirror assembly mounted at the interior portion of the interior cabin of the vehicle, and responsive to the mirror head being adjusted to the display mode orientation, the video display screen is electrically operated to display video images representative of the rearward view for viewing by the driver of the vehicle through the mirror reflector of the mirror reflective element.

2. The vehicular interior rearview mirror assembly of claim 1, wherein the mirror reflector is disposed at the second planar surface of the single glass substrate.

3. The vehicular interior rearview mirror assembly of claim 1, wherein the mirror reflector is disposed at the first planar surface of the single glass substrate.

4. The vehicular interior rearview mirror assembly of claim 1, wherein the adjustment mechanism comprises a detent interface having respective detent positions to retain the mirror head at the mirror mode orientation and the display mode orientation.

5. The vehicular interior rearview mirror assembly of claim 4, wherein the video display screen is electrically operated to display the video images responsive to engagement of the detent interface corresponding to the display mode orientation.

6. The vehicular interior rearview mirror assembly of claim 1, wherein the adjustment mechanism comprises a toggle mechanism that is manually movable relative to the mirror head to adjust the mirror head between at least the mirror mode orientation and the display mode orientation.

7. The vehicular interior rearview mirror assembly of claim 1, wherein the mounting structure comprises (i) a mounting arm having a ball member at an end of the mounting arm and (ii) a socket element disposed at the mirror head, and wherein the socket element pivotally receives the ball member of the mounting arm, and wherein the mirror head is adjustable about the ball member of the mounting arm.

8. The vehicular interior rearview mirror assembly of claim 7, wherein, when the mirror head is adjusted between the mirror mode orientation and the display mode orientation, the mirror head is tilted relative to the socket element.

9. The vehicular interior rearview mirror assembly of claim 1, wherein, when the mirror head is adjusted between the mirror mode orientation and the display mode orientation, the mirror head is tilted about a pivot axis that is parallel to a longitudinal axis of the mirror head.

10. The vehicular interior rearview mirror assembly of claim 9, wherein, when the mirror head is adjusted from the mirror mode orientation toward the display mode orientation, the mirror head is tilted upward about the pivot axis.

11. The vehicular interior rearview mirror assembly of claim 9, wherein, when the mirror head is adjusted from the mirror mode orientation toward the display mode orientation, the mirror head is tilted downward about the pivot axis.

12. The vehicular interior rearview mirror assembly of claim 1, wherein the vehicular interior rearview mirror assembly does not accommodate electronic dimming circuitry.

13. The vehicular interior rearview mirror assembly of claim 1, wherein the adjustment mechanism comprises an electrically operable actuator that, when electrically operated, adjusts the mirror head between the mirror mode orientation and the display mode orientation.

14. The vehicular interior rearview mirror assembly of claim 13, wherein, with the vehicular interior rearview mirror assembly mounted at the interior portion of the interior cabin of the vehicle, the adjustment mechanism adjusts the mirror head from the mirror mode orientation to the display mode orientation based on glare light emanating from a headlight of a trailing vehicle being greater than a threshold level of glare light.

15. The vehicular interior rearview mirror assembly of claim 1, wherein, with the vehicular interior rearview mirror assembly mounted at the interior portion of the interior cabin of the vehicle, and with the mirror head in the mirror mode orientation, and based on glare light emanating from a headlight of a trailing vehicle, the video display screen is electrically operated to reduce the glare light that is reflected by the mirror reflective element toward the driver of the vehicle.

16. The vehicular interior rearview mirror assembly of claim 1, wherein, with the vehicular interior rearview mirror assembly mounted at the interior portion of the interior cabin of the vehicle, and with the video display screen electrically operating to display video images, the video images are electronically dimmable based on at least one selected from the group consisting of (i) glare light emanating from a headlight of a trailing vehicle and (ii) ambient light at the vehicle.

17. A vehicular interior rearview mirror assembly, the vehicular interior rearview mirror assembly comprising:
a mirror head adjustable relative to a mounting structure, wherein the mounting structure is configured to mount the vehicular interior rearview mirror assembly at an interior portion of an interior cabin of a vehicle;
wherein the mirror head accommodates a mirror reflective element;
wherein the mirror reflective element consists of a single glass substrate having a first planar surface and a second planar surface opposite the first planar surface and separated from the first planar surface by a thickness of the single glass substrate, and wherein the second planar surface is parallel to the first planar surface, and wherein the single glass substrate has a mirror reflector disposed at the second planar surface of the single glass substrate;
wherein, with the vehicular interior rearview mirror assembly mounted at the interior portion of the interior cabin of the vehicle, the mirror head is adjustable by a driver of the vehicle to set a rearward view for the driver of the vehicle;
wherein the mirror head accommodates a video display screen;
wherein, with the vehicular interior rearview mirror assembly mounted at the interior portion of the interior cabin of the vehicle, the video display screen is electrically operable to display video images for viewing by the driver of the vehicle through the mirror reflector of the mirror reflective element;
an adjustment mechanism that, with the vehicular interior rearview mirror assembly mounted at the interior portion of the interior cabin of the vehicle, is operable to adjust the mirror head between (i) a mirror mode orientation where the mirror head is positioned relative to the mounting structure so that reflections at the mirror reflective element provide the rearward view for the driver of the vehicle and (ii) a display mode orientation where the mirror head is tilted from the mirror mode orientation so that reflections at the mirror reflective element are directed away from the driver of the vehicle;
wherein, when the mirror head is adjusted between the mirror mode orientation and the display mode orientation, the mirror head is tilted about a pivot axis that is parallel to a longitudinal axis of the mirror head;
wherein, when the mirror head is adjusted from the mirror mode orientation toward the display mode orientation, the mirror head is tilted upward about the pivot axis; and
wherein, with the vehicular interior rearview mirror assembly mounted at the interior portion of the interior cabin of the vehicle, and responsive to the mirror head being adjusted to the display mode orientation, the video display screen is electrically operated to display video images representative of the rearward view for viewing by the driver of the vehicle through the mirror reflector of the mirror reflective element.

18. The vehicular interior rearview mirror assembly of claim 17, wherein the vehicular interior rearview mirror assembly does not accommodate electronic dimming circuitry.

19. The vehicular interior rearview mirror assembly of claim 17, wherein the adjustment mechanism comprises an electrically operable actuator that, when electrically operated, adjusts the mirror head between the mirror mode orientation and the display mode orientation.

20. The vehicular interior rearview mirror assembly of claim 19, wherein, with the vehicular interior rearview mirror assembly mounted at the interior portion of the interior cabin of the vehicle, the adjustment mechanism adjusts the mirror head from the mirror mode orientation to the display mode orientation based on glare light emanating from a headlight of a trailing vehicle being greater than a threshold level of glare light.

21. The vehicular interior rearview mirror assembly of claim 17, wherein, with the vehicular interior rearview mirror assembly mounted at the interior portion of the interior cabin of the vehicle, and with the mirror head in the mirror mode orientation, and based on glare light emanating from a headlight of a trailing vehicle, the video display screen is electrically operated to reduce the glare light that is reflected by the mirror reflective element toward the driver of the vehicle.

22. The vehicular interior rearview mirror assembly of claim 17, wherein, with the vehicular interior rearview mirror assembly mounted at the interior portion of the interior cabin of the vehicle, and with the video display screen electrically operating to display video images, the video images are electronically dimmable based on at least one selected from the group consisting of (i) glare light emanating from a headlight of a trailing vehicle and (ii) ambient light at the vehicle.

23. A vehicular interior rearview mirror assembly, the vehicular interior rearview mirror assembly comprising:
a mirror head adjustable relative to a mounting structure, wherein the mounting structure is configured to mount the vehicular interior rearview mirror assembly at an interior portion of an interior cabin of a vehicle;
wherein the mirror head accommodates a mirror reflective element;
wherein the mirror reflective element consists of a single glass substrate having a first planar surface and a second planar surface opposite the first planar surface and separated from the first planar surface by a thickness of the single glass substrate, and wherein the second planar surface is parallel to the first planar surface, and wherein the single glass substrate has a mirror reflector;
wherein, with the vehicular interior rearview mirror assembly mounted at the interior portion of the interior cabin of the vehicle, the mirror head is adjustable by a driver of the vehicle to set a rearward view for the driver of the vehicle;
wherein the mirror head accommodates a video display screen;
wherein, with the vehicular interior rearview mirror assembly mounted at the interior portion of the interior cabin of the vehicle, the video display screen is electrically operable to display video images for viewing by the driver of the vehicle through the mirror reflector of the mirror reflective element;
an adjustment mechanism that, with the vehicular interior rearview mirror assembly mounted at the interior portion of the interior cabin of the vehicle, is operable to adjust the mirror head between (i) a mirror mode orientation where the mirror head is positioned relative to the mounting structure so that reflections at the mirror reflective element provide the rearward view for the driver of the vehicle and (ii) a display mode orientation where the mirror head is tilted from the mirror mode orientation so that reflections at the mirror reflective element are directed away from the driver of the vehicle;
wherein the adjustment mechanism comprises a toggle mechanism that is manually movable relative to the mirror head to adjust the mirror head between at least the mirror mode orientation and the display mode orientation;
wherein, with the vehicular interior rearview mirror assembly mounted at the interior portion of the interior cabin of the vehicle, and responsive to the mirror head being adjusted to the display mode orientation, the video display screen is electrically operated to display video images representative of the rearward view for viewing by the driver of the vehicle through the mirror reflector of the mirror reflective element; and
wherein, with the vehicular interior rearview mirror assembly mounted at the interior portion of the interior cabin of the vehicle, and with the mirror head in the mirror mode orientation, and based on glare light emanating from a headlight of a trailing vehicle, the video display screen is electrically operated to reduce the glare light that is reflected by the mirror reflective element toward the driver of the vehicle.

24. The vehicular interior rearview mirror assembly of claim 23, wherein the mirror reflector is disposed at the second planar surface of the single glass substrate.

25. The vehicular interior rearview mirror assembly of claim 23, wherein the mirror reflector is disposed at the first planar surface of the single glass substrate.

26. The vehicular interior rearview mirror assembly of claim 23, wherein the vehicular interior rearview mirror assembly does not accommodate electronic dimming circuitry.
